(19) United States
(12) Patent Application Publication
(10) Pub. No.: US 2005/0255771 A1
(43) Pub. Date: Nov. 17, 2005

(54) Sheet structure for combination flash flame and chemical splash protection garments and process for making same

(76) Inventors: Ashok S. Chetty, Richmond, VA (US); Oscar L. Martin JR., Midlothian, VA (US); James P. Zeigler, Richmond, VA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/843,045

(22) Filed: May 11, 2004

(51) Int. Cl. B32B 5/02; B32B 27/04; B32B 27/12

(52) U.S. Cl. 442/136; 442/59; 442/153; 442/154

(57) ABSTRACT

This invention is related to a flexible sheet structure useful in garments for providing combination flash flame and chemical splash protection, and a garment comprising such flexible sheet structure, the flexible sheet structure comprising a fabric layer comprising flame retardant fibers, a chemical barrier layer being able to provide greater than 60 minute chemical permeation pursuant to ASTM F739 for at least 11 of the 21 chemicals listed in this test procedure, and a continuous outer polymer layer; the flexible sheet structure having a thermal shrinkage resistance of less than 10 percent when tested according to NFPA 2112, and having an after flame performance of less than 2 seconds and a char length of not more than 4 inches (100 mm) when tested per ASTM D6413.

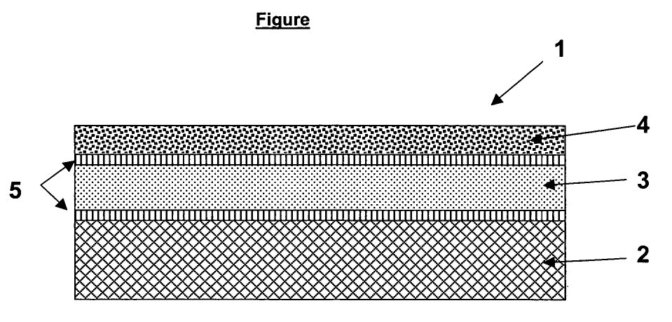

### BACKGROUND

1. Field of the Invention

This invention is related to a flexible sheet structure useful in garments for providing combination flash flame and chemical splash protection, and a garment comprising such flexible sheet structure; the sheet structure comprising a fabric layer comprising flame retardant fibers, a non-flame retardant chemical barrier layer being able to provide greater than 60 minute chemical permeation pursuant to ASTM F739 for at least 11 of the 21 chemicals listed in this test procedure, and a continuous outer polymer layer; the flexible sheet structure having a thermal shrinkage resistance of less than 10 percent when tested according to NFPA 2112, and having an after flame performance of less than 2 seconds and a char length of not more than 4 inches (100 mm) when tested per ASTM D6413.

2. Description of Related Art

Emergency responders need protective apparel that will protect them from multiple types of threats, such as flames and hazardous chemicals. However, protective apparel has generally been either directed primarily to protecting one from flames or from hazardous chemicals, but not both.

Those garments that can be used for both flash flame and chemical threats tend to be very costly due to the costly materials used in the construction of such garments. In particular, garments utilizing fluoropolymers in various forms, such as in chemical barrier films, are very useful in that they provide excellent chemical protection while being also generally flame retardant; however, these are very costly materials and they can add significantly to the cost of protective apparel. For those situations where the chemical hazard is particularly difficult to address, fluoropolymers can be a good choice in protective apparel and the cost is acceptable. However, in many instances, protective apparel that contains fluoropolymers is overdesigned, that is, it meets many more chemical threats than is typically necessary. Other polymer materials are available that are very inexpensive and also have generally good chemical permeation performance; that is, they prevent passage of a wide variety of potentially hazardous chemicals. However, these polymer materials are generally not flame retardant and have therefore not been used in garments where flame retardancy was desired.

Therefore, what is needed is a way to incorporate such inexpensive non-flame-retardant polymer materials into a flexible sheet structure suitable for use in protective garments, in a way that the flexible sheet structure provides not only chemical permeation protection but also provides flash flame protection.

U.S. Pat. No. 6,531,419 to Wyner et al. discloses a multi-layer protective fabric that includes a thin urethane film, a flame-retardant fibrous layer, and a flame-retardant microporous film layer. The layers are adhesively bonded to one another by the use of a flame retardant adhesive.

U.S. Pat. No. 4,816,330 to Freund, et al. discloses a chemical resistant garment material that is a laminate formed from layers of skived Teflon® that have been adhesively adhered to a cloth substrate. The cloth substrate provides strength to the skived Teflon® layer and can be made from any number of materials, including Nomex® aramid fiber.

International PCT Application WO 9208609 to Enzien et al. discloses a leather-like flexible multilayer fluoropolymer laminate for use in protective apparel, the laminate having a first layer of fluoropolymer film laminated to a second layer that is a nonwoven substrate, the nonwoven substrate having laminated to its other side a barrier layer; a fourth layer in the laminate is a woven glass substrate coated with more fluoropolymer. Optionally, another layer of fluoropolymer film can be included in the laminate.

U.S. Pat. No. 5,226,384 to Jordan discloses a Kevlar® aramid sheet adhesively bonded to a Mylar® polyester sheet for use in damage resistant animal beds. Such materials are used because of their durable nature.

U.S. Pat. No. 4,708,080 discloses Kevlar® aramid fiber as thread line force bearing materials in a sailcloth laminate that includes Mylar® film. The patent discloses polyurethane and other films may be used instead of the Mylar® film. Such sailcloth laminates are not constructed with regard to flame retardancy.

### SUMMARY OF THE INVENTION

This invention is related to a flexible sheet structure useful in garments for providing both flash flame and chemical splash protection, and a garment comprising such sheet structure, the sheet structure comprising a fabric layer comprising fibers that have a limiting oxygen index of greater than 23, a chemical barrier layer comprising a non-flame retardant polymer, the layer being able to provide greater than 60 minute chemical permeation pursuant to ASTM F739 for at least 11 of the 21 chemicals listed in this test procedure, and a continuous outer polymer layer that is flame retardant, the flexible sheet structure having a thermal shrinkage resistance of less than 10 percent when tested according to NFPA 2112, and having an after flame performance of less than 2 seconds and a char length of not more than 4 inches (100 mm) when tested per ASTM D6413.

This invention also relates to a process for making a flexible sheet structure useful in providing both flash flame and chemical splash protection, the steps comprising:
a) superposing the layers of the flexible sheet structure, with a flame retardant adhesive between each layer, the layers comprising a fabric layer comprising fibers that have a limiting oxygen index of greater than 23, a chemical barrier layer comprising a non-flame retardant polymer, the chemical barrier layer being able to provide greater than 60 minute chemical permeation pursuant to ASTM F739 for at least 11 of the 21 chemicals listed in this test procedure, and a continuous outer polymer layer that is flame retardant,
b) compressing the layers and adhesive together to form a laminate, and
c) curing the adhesive in the laminate with heat.

This invention further relates to a process for making a flexible sheet structure useful in providing both flash flame and chemical splash protection, the steps comprising:
a) superposing a chemical barrier layer comprising a non-flame retardant polymer, the chemical barrier layer being able to provide greater than 60 minute chemical permeation pursuant to ASTM F739 for at least 11 of the 21 chemicals listed in this test procedure, and a continuous outer polymer layer that is flame retardant, a flame retardant adhesive positioned therebetween,
b) compressing the layers and adhesive together to form a polymer laminate,
c) superposing a fabric layer comprising fibers that have a limiting oxygen index of greater than 23 with the polymer laminate, a flame retardant adhesive positioned therebetween,
d) compressing the fabric layer, the polymer laminate, and adhesive together to form a laminate, and
e) curing the adhesive in the laminate with heat to form a flexible sheet structure.

### BRIEF DESCRIPTION OF DRAWINGS

The FIGURE is a sectional side elevation view of a preferred version of the flexible sheet structure of this invention.

### DETAILS OF THE INVENTION

Flexible Sheet Structure

This invention concerns a flexible sheet structure useful in garments for providing combination flash flame and chemical splash protection, and a garment comprising such flexible sheet structure, the flexible sheet structure comprising a fabric layer comprising flame retardant fibers, a non-flame retardant chemical barrier layer, and a continuous outer polymer layer; the flexible sheet structure having a thermal shrinkage resistance of less than 10 percent when tested according to NFPA 2112, and having an after flame performance of less than 2 seconds and a char length of not more than 4 inches (100 mm) when tested per ASTM D6413. The flexible sheet structure also provides greater than 60 minute chemical permeation pursuant to ASTM F739 for at least 11 of the 21 chemicals listed in this test procedure.

The layers of the flexible sheet structure preferably are attached together by an adhesive that does not make the sheet structure more flammable. The preferred adhesive is one that is actually flame retardant. The combined layers of the flexible sheet structure preferably has a basis weight of from 99 to 660 grams per square meter (3 to 20 ounces per square yard).

The Fabric Layer

One layer of the flexible sheet structure is a fabric layer comprising fibers that have a limiting oxygen index of greater than 23, preferably greater than 26. Such fabric layers can be, for example woven or nonwoven fabrics or felts, however nonwoven fabrics are preferred.

Such nonwoven fabrics can be made by conventional nonwoven sheet forming processes, including processes for making air-laid nonwovens or wet-laid nonwovens, and such formed sheets can be consolidated into fabrics via spunlacing, hydrolacing, needlepunching, or other processes which can generate a nonwoven sheet. The spunlaced processes disclosed in U.S. Pat. No. 3,508,308 and U.S. Pat. No. 3,797,074; and the needlepunching processes disclosed in U.S. Pat. No. 2,910,763 and U.S. Pat. No. 3,684,284 are examples of methods well-known in the art that are useful in the manufacture of the nonwoven fabrics. The preferred nonwoven fabrics of this invention are air-laid spunlaced or hydrolaced nonwovens where high pressure water jets are used to entangle fibers into a cohesive sheet.

The fabric layer has a basis weight of from 33.9 to 339 grams per square meter (1 to 10 ounces per square yard). Fabric layers having a basis weight of less than that range are not expected to provide the flexible sheet structure with adequate strength, while fabric layers having basis weights in excess of that range tend to be too stiff to make an acceptable flexible sheet structure.

The fabric layer comprises fibers that are normally flame resistant, meaning those fibers or fabric made from the fibers have a Limiting Oxygen Index (LOI) such that the fiber or fabric will not support a flame in air, the preferred LOI range being greater than 23, preferably greater than 26. It is preferred that the fabric layer contain some high-LOI fibers that do not excessively shrink when exposed to a flame, that is, the length of the fiber will not significantly shorten when exposed to flame.

The flame resistant fibers useful in the fabric layer of this invention include fiber made from meta-aramid, para-aramid, polybenzazole, polybenzimidazole, and polyimide polymer. The preferred heat resistant fiber is made from aramid polymer, and the preferred aramid polymer is meta-aramid).

As used herein, “aramid” is meant a polyamide wherein at least 85% of the amide (—CONH—) linkages are attached directly to two aromatic rings. Meta-aramid means the two rings or radicals are meta oriented with respect to each other along the molecular chain and para-aramid means the two rings or radicals are para oriented with respect to each other along the molecular chain; the rings can be unsubstituted or substituted. Copolymers are included, having as much as 10 percent of other diamine substituted for a primary diamine used in forming the polymer, or as much as 10 percent of other diacid chloride substituted for a primary diacid chloride used in forming the polymer. Additives can be included in the polymer; up to as much as 10 percent, by weight, of other polymeric material can be blended with or bonded to the polymer.

In the practice of this invention, the preferred meta-aramid is poly(meta-phenylene isophthalamide) and the preferred para-aramid is poly(paraphenylene terephthalamide). Methods for making aramid fibers, including meta-aramid fibers and para-aramid fibers useful in this invention are well-known and generally disclosed in, for example, U.S. Pat. Nos. 3,063,966; 3,094,511; 3,287,324; 3,869,430; 3,869,429; and 3,767,756. Such aromatic polyamide organic fibers and various forms of these fibers are available from DuPont Company, Wilmington, Del. under the trademarks of Nomex® and Kevlar® fibers.

Commercially available polybenzazole fibers useful in this invention include Zylon® PBO-AS (Poly(p-phenylene-2,6-benzobisoxazole) fiber, Zylon® PBO-HM (Poly(p-phenylene-2,6-benzobisoxazole)) fiber, available from Toyobo, Japan. Commercially available polybenzimidazole fibers useful in this invention include PBI® fiber available from Celanese Acetate LLC. Commercially available polyimide fibers useful in this invention include P-84® fiber available from LaPlace Chemical.

The flame resistant fibers useful in this invention can also be cellulose fibers containing or treated with a flame retardant chemical. Such cellulose fibers can include rayon and cotton. Other fibers that can be used in this invention include wool, modacrylic, polyvinyl chloride, melamine, and polyamide-imide. Any of these fibers can contain, if needed, a phosphorous, bromine, and/or chlorine compounds, or other flame retardant additives for improved flame retardancy

The Chemical Barrier Layer

Another layer of the flexible sheet structure is a chemical barrier layer comprising a non-flame retardant polymer, the layer being able to provide greater than 60 minute chemical permeation pursuant to ASTM F739 for at least 11 of the 21 chemicals listed in this test procedure. The chemical barrier layer contains a polymer that is not flame retardant, that is, that polymer will burn in air or has an LOI of less than 21. Preferably, the entire chemical barrier layer is not flame retardant. Other than for flame retardancy, almost any polymer may be used in this layer, for example, a thermoplastic or thermoset homopolymer or copolymer or polymer blend, as long as it has the desired chemical permeation performance. Example non-flame retardant polymers include polyetheresters, polyacrylonitriles, polyamides and polyesters, with polyester being the preferred polymer for this layer.

The polymer in the chemical barrier layer of the flexible sheet structure can be in the form of a coating, an extruded polymer layer, or a film, with a polymer film being preferred. The chemical barrier layer has a thickness of up to 0.15 mm (6 mils), preferably a thickness of up to 0.025 mm (1 mils). A thickness of greater than 0.15 mm (6 mils) adds greatly to the stiffness of the flexible sheet structure and is not desired. While the type and chemical performance of chemical barrier layer determines the minimum thickness that can be used, it is thought that as a guide for many polymers the chemical barrier layer should be at least 0.006 mm (0.25 mils) in thickness.

The Continuous Outer Polymer Layer

Another layer of the flexible sheet structure is a continuous outer polymer layer that is flame retardant. It preferably also has a thermal shrinkage resistance of less than 10 percent.

The continuous outer polymer layer forms the primary outer surface of the flexible sheet structure and therefore should be durable and flame retardant, that is, the layer should not burn in air. By continuous it is meant the outer layer forms a continuous covering of the chemical barrier layer, protecting that layer from flame. Preferably, the continuous outer polymer layer is made flame retardant by loading the polymer used in that layer with flame retardant chemical particles. Almost any durable polymer may be used in this layer, for example a thermoplastic or thermoset homopolymer or copolymer or polymer blend. Useful polymers include, for example, elastomers, polyvinyls, fluoroelastomers, and polyurethanes, with polyurethane being the preferred polymer for this layer.

The polymer in the continuous outer polymer layer of the flexible sheet structure can be in the form of a coating, an extruded polymer layer, or a film, with a polymer film being preferred. The continuous outer polymer layer has a thickness of about 0.038 to 0.50 mm (1.5 to 20 mils), preferably a thickness of about 0.076 to 0.13 mm (3 to 5 mils). A thickness of greater than about 0.50 mm (20 mils) is undesirable because it adds greatly to the stiffness of the flexible sheet without appreciable protective benefit, while a thickness of less than about 0.038 (1.5 mils) is thought to not provide adequate flame retardancy protection for the chemical barrier layer.

Assembly of Layers

The fabric layer, the non-flame retardant chemical barrier layer, and the continuous outer polymer layer are assembled together to form the flexible sheet structure of this invention. Preferably, the layers are attached together by an adhesive that does not make the sheet structure more flammable. The preferred adhesive is a flame retardant adhesive. Suitable adhesives include urethane-based or silicone-based adhesives.

Preferably, the flexible sheet structure is made by attaching together the fabric layer, the chemical barrier layer, and the continuous outer polymer layer, with the chemical barrier layer positioned between the other two layers. The FIGURE is a sectional side elevation view of a preferred version of the flexible sheet structure of this invention. Flexible sheet structure 1 is made by superposing, in order, fabric layer 2, non-flame retardant chemical barrier layer 3, and continuous outer polymer layer 4 with a layer of flame retardant adhesive 5 between layers 2 and 3 and between layers 3 and 4. As shown in the FIGURE, preferably the continuous outer polymer layer is in full contact with the chemical barrier layer, either directly or through both layers being in full contact with intervening or common adhesive layer(s). Most preferably all layers are in full contact with the adjacent layers, either directly or with the layers being in full contact with intervening or common adhesive layer(s).

While not desired, other layers may be employed or attached to the flexible sheet structure in any manner as long as the function and properties of the sheet structure are not adversely affected. However, for flame retardancy, it is critical that the non-flame retardant chemical barrier layer be an inner layer of the flexible sheet structure.

Protective Garments Incorporating the Sheet Structure

This invention further includes a protective garment made from the flexible sheet structures of this invention. Such garments provide greater than 60 minute chemical permeation pursuant to ASTM F739 for at least 11 of the 21 chemicals listed in this test procedure, have a thermal shrinkage resistance of less than 10 percent when tested according to NFPA 2112, and having an after flame performance of less than 2 seconds and a char length of not more than 4 inches (100 mm) when tested per ASTM D6413.

Such garments are preferably made from a flexible sheet structure wherein the fabric layer, the chemical barrier layer, and the continuous outer polymer layer are attached together with the chemical barrier layer positioned between the other two layers. Preferably, the layers are attached together by a flame retardant adhesive.

Garments of this invention include coats, jackets, pants, overalls, full body suits, headgear, aprons, gloves, and any other form of apparel that could be used to protect something from chemical or flash flame hazards.

Processes for Making the Sheet Structure

This invention also relates to a process for making a flexible sheet structure useful in providing both flash flame and chemical splash protection, the process steps comprising:
a) superposing the layers of the flexible sheet structure, with a flame retardant adhesive between each layer; the layers comprising a fabric layer comprising fibers that have a limiting oxygen index of greater than 23; a chemical barrier layer comprising a non-flame retardant polymer, the layer being able to provide greater than 60 minute chemical permeation pursuant to ASTM F739 for at least 11 of the 21 chemicals listed in this test procedure; and a continuous outer polymer layer that is flame retardant,
b) compressing the layers and adhesive together to form a laminate, and
c) curing the adhesive in the laminate with heat.

An alternative process for making a flexible sheet structure of this invention comprises the steps of:
a) superposing a chemical barrier layer comprising a non-flame retardant polymer, the layer being able to provide greater than 60 minute chemical permeation pursuant to ASTM F739 for at least 11 of the 21 chemicals listed in this test procedure; and a continuous outer polymer layer that is flame retardant, a flame retardant adhesive positioned therebetween,
b) compressing the layers and adhesive together to form a polymer laminate,
c) superposing a fabric layer comprising fibers that have a limiting oxygen index of greater than 23 with the polymer laminate, a flame retardant adhesive positioned therebetween,
d) compressing the fabric layer, the polymer laminate, and adhesive together to form a laminate, and
e) curing the adhesive in the laminate with heat to form a flexible sheet structure.

The adhesive can be applied to the layers by any convenient method that will give a uniform application, such spray coating or knife coating. The adhesive can be applied to one side of a layer, and then the next layer overlaid over the adhesive and then adhesive can be applied to that layer in turn. For example, adhesive can be applied to one side of the continuous outer polymer layer and then the chemical barrier layer overlaid on top of the adhesive. Adhesive can then be applied to the other side of the chemical barrier layer and the fabric layer laid on top of that adhesive. Alternatively, the adhesive can be applied to the fabric layer and then this can be laid on top of the chemical barrier layer with the adhesive between the fabric and chemical barrier layers. The adhesive can be doctored to ensure a uniform thickness. Once a layer having adhesive applied is overlaid with another layer, the layers can be partially compressed prior to the addition of more adhesive or other layers.

Once all the layers are assembled, the laminate is then compressed to the desired thickness using a pair of rolls with a set gap between the roll surfaces. The adhesive is then cured by the application of heat. Preferably, the heat is applied via a heated oven, although other methods, such as simultaneously compressing and heating the laminate in a nip, may be used in some instances. Typical oven temperatures range from about 93 to 260° C. (200 to 500° F.). If desired, the adhesive can be cured in stages, that is, once two layers have been overlaid with adhesive positioned between the layers, that assembly can be partially or fully cured, followed by applying adhesive to that assembly and adding more layers, followed by curing of any additional adhesive.

### Test Methods

Chemical permeation through the chemical barrier layer is measured using ASTM F739, with “greater than 60 minute chemical permeation” meaning it takes more than 60 minutes to reach a permeation rate of 0.1 micrograms per square centimeter per minute of the chemical through the material. Thermal shrinkage resistance of the flexible sheet structure and the outer polymer layer was measured using NFPA 2112, and flame performance of the flexible sheet structure was measured using ASTM D6413.

### EXAMPLES

In a first lamination, a continuous outer polymer layer comprised of two extruded films was made by extruding a first film of polyurethane polymer, having a lime green color and a brominated-based flame-retardant chemical additive, onto a smooth release paper. A second film of polyurethane polymer having a white color was then extruded directly on top of the lime green film, to improve the opacity of the continuous outer polymer layer. The film layers were then sent through a nip, formed by a set of rolls, to control and consolidate the film thickness of the continuous outer polymer layer to 0.101 mm (4 mils). Exiting the nip, a silicone-based adhesive was fed on top of the white colored polyurethane film, and then sent through another nip, formed by another set of rolls, to control the adhesive add-on to 41 g/m² (1.2 oz/yd²) on the film. After exiting this nip, a chemical barrier layer of 0.013 mm (0.5 mil) Mylar® LBT2 polyester film was laid directly on top of the adhesive layer and the combination was nipped through rolls and sent through an air dryer oven. This Mylar® film provides greater than 60 minute chemical permeation pursuant to ASTM F739 for at least 11 of the 21 chemicals listed in this test procedure. Because the films were non-porous, no volatiles were removed in the dryer. The film laminate, including the release paper, was then wound up into a roll at the exit of the dryer oven.

In a second lamination, the film laminate was then unwound and the same type of silicone-based adhesive used previously was metered directly onto the chemical barrier layer of the film laminate (the Mylar® film), and then was nipped between rolls to a provide a uniform 41 g/m² (1.2 oz/yd²) add-on level of adhesive on the surface of the laminate. After exiting the nip, a 119 g/m² (3.5 oz/yd²) aramid olive green spunlaced fabric (made from a blend of 92% meta-aramid fiber, 5% para-aramid fiber, and 3% nylon sheath/carbon core antistatic fiber) was fed on top of the adhesive layer. The resulting sheet structure was nipped between another set of rolls and sent through the dryer oven to remove excess volatiles and cure the adhesive. The release paper was removed and the flexible sheet structure was wound up into a roll at the exit of the dryer oven.

A hooded coverall was then made from the flexible sheet structure, with sheet structure positioned so that the aramid fabric side faced the wearer. The seams were stitched using Nomex® thread and were then serged and taped on the inside using a fluoropolymer tape. The tape was adhered to the fabric using conventional hot air tape equipment. The garment had a center front zipper closure with a full-length exterior storm flap. The zipper was made of Nomex® 28″-32″ sage green fabric tape and had brass teeth. Flame retardant Velcro® was used to adhere the storm flap, and elastic was incorporated at the wrists.

The flexible sheet structure had a thermal shrinkage resistance of less than 10 percent when tested according to NFPA 2112, and had an after flame performance of less than 2 seconds and a char length of not more than 4 inches (100 mm) when tested per ASTM D6413.

1. A flexible sheet structure useful in garments for providing both flash flame and chemical splash protection, comprising:
(a) a fabric layer comprising fibers that have a limiting oxygen index of greater than 23,
(b) a chemical barrier layer comprising a non-flame retardant polymer, the layer being able to provide greater than 60 minute chemical permeation pursuant to ASTM F739 for at least 11 of the 21 chemicals listed in this test procedure, and
(c) a continuous outer polymer layer, the layer being flame retardant;
the flexible sheet structure having a thermal shrinkage resistance of less than 10 percent when tested according to NFPA 2112, and having an after flame performance of less than 2 seconds and a char length of not more than 4 inches (100 mm) when tested per ASTM D6413.

2. The flexible sheet structure of claim 1, wherein the fabric layer is a nonwoven fabric.

3. The flexible sheet structure of claim 1, wherein the fabric layer has a basis weight of from 33.9 to 339 grams per square meter (1 to 10 ounces per square yard).

4. The flexible sheet structure of claim 1, wherein the fabric layer comprises aramid fibers.

5. The flexible sheet structure of claim 1, wherein the fabric layer comprises flame retardant cellulose fibers.

6. The flexible sheet structure of claim 1, wherein the non-flame retardant polymer in the chemical barrier layer is in the form of a polymer film.

7. The flexible sheet structure of claim 1, wherein the non-flame retardant polymer in the chemical barrier layer comprises a polyester polymer.

8. The flexible sheet structure of claim 1, wherein the non-flame retardant polymer comprises a polyetherester polymer, a polyacrylonitrile polymer, or a polyamide polymer.

9. The flexible sheet structure of claim 1, wherein the chemical barrier layer has a thickness of up to 0.15 mm (6 mils).

10. The flexible sheet structure of claim 9, wherein the chemical barrier layer has a thickness of up to 0.025 mm (1 mils).

11. The flexible sheet structure of claim 1, wherein the continuous outer polymer layer is in the form of a polymer film.

12. The flexible sheet structure of claim 1, wherein the continuous outer polymer layer comprises a polyurethane polymer.

13. The flexible sheet structure of claim 1, wherein the continuous outer polymer layer comprises an elastomer, a polyvinyl polymer, or a fluoroelastomer.

14. The flexible sheet structure of claim 1, wherein the continuous outer polymer layer has a thickness of 0.038 to 0.50 mm (1.5 to 20 mils).

15. The flexible sheet structure of claim 14, wherein the continuous outer polymer layer has a thickness of 0.076 to 0.13 mm (3 to 5 mils).

16. The flexible sheet structure of claim 1, wherein the continuous outer polymer layer is made flame retardant by loading the polymer with a flame retardant.

17. The flexible sheet structure of claim 1 having a basis weight of from 99 to 660 grams per square meter (3 to 20 ounces per square yard).

18. The flexible sheet structure of claim 11, wherein the layers are attached with a flame retardant adhesive.

19. The flexible sheet structure of claim 1, wherein the fabric layer, the chemical barrier layer, and the continuous outer polymer layer are attached together with the chemical barrier layer positioned between the other two layers.

20. A protective garment comprising the flexible sheet structure of claim 1.

21. A protective garment comprising the flexible sheet structure of claim 19.

22. A process for making a flexible sheet structure useful in providing both flash flame and chemical splash protection, the steps comprising:
a) superposing the layers of the flexible sheet structure, with a flame retardant adhesive between each layer, the layers comprising:
(i) a fabric layer comprising fibers that have a limiting oxygen index of greater than 23,
(ii) a chemical barrier layer comprising a non-flame retardant polymer, the layer being able to provide greater than 60 minute chemical permeation pursuant to ASTM F739 for at least 11 of the 21 chemicals listed in this test procedure, and
(iii) a continuous outer polymer layer, the layer being flame retardant,
b) compressing the layers and adhesive together to form a laminate, and
c) curing the adhesive in the laminate with heat.

23. A process for making a flexible sheet structure useful in providing both flash flame and chemical splash protection, the steps comprising:
a) superposing
(i) a chemical barrier layer comprising a non-flame retardant polymer, the layer being able to provide greater than 60 minute chemical permeation pursuant to ASTM F739 for at least 11 of the 21 chemicals listed in this test procedure, and
(ii) a continuous outer polymer layer, the layer being flame retardant,
a flame retardant adhesive positioned therebetween,
b) compressing the layers and adhesive together to form a polymer laminate,
c) superposing a fabric layer comprising fibers that have a limiting oxygen index of greater than 23 with the polymer laminate, a flame retardant adhesive positioned therebetween,
d) compressing the fabric layer, the polymer laminate, and adhesive together to form a laminate, and
e) curing the adhesive in the laminate with heat to form a flexible sheet structure.

24. The process of claim 23, wherein the polymer laminate of step b) is cured with heat prior to step c).
